(19) United States
(12) Patent Application Publication
(10) Pub. No.: US 2014/0295905 A1
(43) Pub. Date: Oct. 2, 2014

(54) Switching Cells On And Off On A Need Basis In A Wireless Communications Systems

(71) Applicants: Jussi-Pekka Koskinen, Oulu (FI); Jarkko Koskela, Oulu (FI); Lars Dalsgaard, Oulu (FI)

(72) Inventors: Jussi-Pekka Koskinen, Oulu (FI); Jarkko Koskela, Oulu (FI); Lars Dalsgaard, Oulu (FI)

(73) Assignee: Nokia Corporation, Espoo (FI)

(21) Appl. No.: 14/005,607

(22) PCT Filed: Mar. 18, 2011
(86) PCT No.: PCT/IB11/51153

§ 371 Date: Nov. 13, 2013

(51) Int. Cl. H04W 52/18

(52) U.S. Cl. CPC H04W 52/18
USPC 455/522

(57) ABSTRACT

A method includes detecting that at least one trigger condition is satisfied in a mobile station and, in response, transmitting a message requesting that a base station be turned on. The use of the method, as well as corresponding apparatus and computer programs, serves to optimize energy consumption efficiency of wireless communications networks and systems, and contributes to green approaches to network operation.

### TECHNICAL FIELD

The exemplary and non-limiting embodiments of this invention relate generally to wireless communication systems, methods, devices and computer programs and, more specifically, relate to methods and apparatus to enhance energy efficiency in a radio assess network (RAN).

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

The energy efficiency of telecommunications networks is becoming an important topic. Increased energy efficiency results in at least a reduction in carbon emissions, conservation of energy sources, as well as in reduced operating costs.

For example, reference can be made to 3GPP TS 32.551 V10.0.1 (2011-02) Technical Specification 3rd Generation Partnership Project; Technical Specification Group Services and System Aspects; Telecommunication management; Energy Saving Management (ESM); Concepts and requirements (Release 10). Reference can also be made to 3GPP TR 32.826 V10.0.0 (2010-03) Technical Report 3rd Generation Partnership Project; Technical Specification Group Services and System Aspects. Telecommunication management; Study on Energy Savings Management (ESM) (Release 10).

While useful to some extent, the techniques proposed thus far fall short of fully optimizing the energy efficiency of wireless communications networks.

### SUMMARY

The foregoing and other problems are overcome, and other advantages are realized, in accordance with the exemplary embodiments of this invention.

In a first exemplary aspect thereof the invention provides a method that comprises detecting that at least one trigger condition is satisfied in a mobile station and, in response, transmitting a message requesting that a base station be turned on.

In another exemplary aspect thereof the invention provides an apparatus that comprises a processor and a memory including computer program code. The memory and computer program code are configured to, with the processor, cause the apparatus to detect that at least one trigger condition is satisfied in a mobile station and, in response, to transmit a message requesting that a base station be turned on.

In a further exemplary aspect thereof the invention provides an apparatus that comprises means for detecting that at least one trigger condition is satisfied in a mobile station; and means, responsive to said detecting means, for transmitting a message requesting that a base station be turned on.

In another exemplary aspect thereof the invention provides a method that comprises receiving a request from a mobile station and, in response to the received request, turning on a base station so as to activate a cell for use by the mobile station.

In a still further exemplary aspect thereof the invention provides an apparatus that comprises a processor and a memory including computer program code. The memory and computer program code are configured to, with the processor, cause the apparatus to receive a request from a mobile station and, in response to the received request, turn on a base station so as to activate a cell for use by the mobile station.

In a further exemplary aspect thereof the invention provides an apparatus that comprises means for receiving a request from a mobile station and means, responsive to the received request, for turning on a base station so as to activate a cell for use by the mobile station.

### BRIEF DESCRIPTION OF THE DRAWINGS

The foregoing and other aspects of the exemplary embodiments of this invention are made more evident in the following Detailed Description, when read in conjunction with the attached Drawing Figures, wherein:

FIG. 1A is an overall block diagram of a wireless communications system having network elements and mobile user elements, and that is operated in accordance with the exemplary embodiments of this invention.

FIG. 1B reproduces FIG. 4.1 of 3GPP TS 36.300, and shows the overall architecture of the EUTRAN system.

FIGS. 2A and 2B show simplified block diagrams of a base station and a mobile station, respectively.

FIG. 3 is a logic flow diagram that illustrates the operation of a method, and a result of execution of computer program instructions, in accordance with the exemplary embodiments of this invention.

FIG. 4 is a logic flow diagram that illustrates the operation of a method, and a result of execution of computer program instructions, further in accordance with the exemplary embodiments of this invention.

### DETAILED DESCRIPTION

Although the exemplary embodiments of this invention are not limited for use with any one particular type of wireless system and network, one system that can benefit from the use of the exemplary embodiments is known as evolved UTRAN (E-UTRAN, also referred to as UTRAN-LTE or as E-UTRA). In this system the DL access technique is OFDMA, and the UL access technique is SC-FDMA. One specification of interest is 3GPP TS 36.300, V8.11.0 (2009-12), 3rd Generation Partnership Project; Technical Specification Group Radio Access Network; Evolved Universal Terrestrial Radio Access (E-UTRA) and Evolved Universal Terrestrial Access Network (EUTRAN); Overall description; Stage 2 (Release 8), incorporated by reference herein in its entirety. This system may be referred to for convenience as LIE Rel-8. In general, the set of specifications given generally as 3GPP TS 36.xyz (e.g., 36.211, 36.311, 36.312, etc.) may be seen as describing the Release 8 LTE system. More recently, Release 9 and Release 10 versions of at least some of these specifications have been published including 3GPP TS 36.300, V10.2.0 (2010-12). An evolution of this system is known as LIE-Advanced.

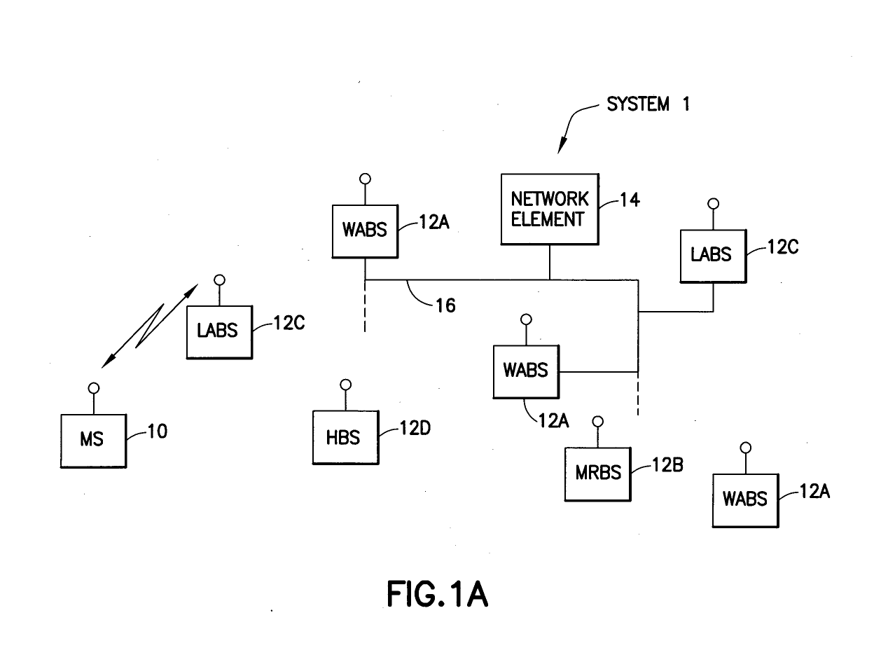

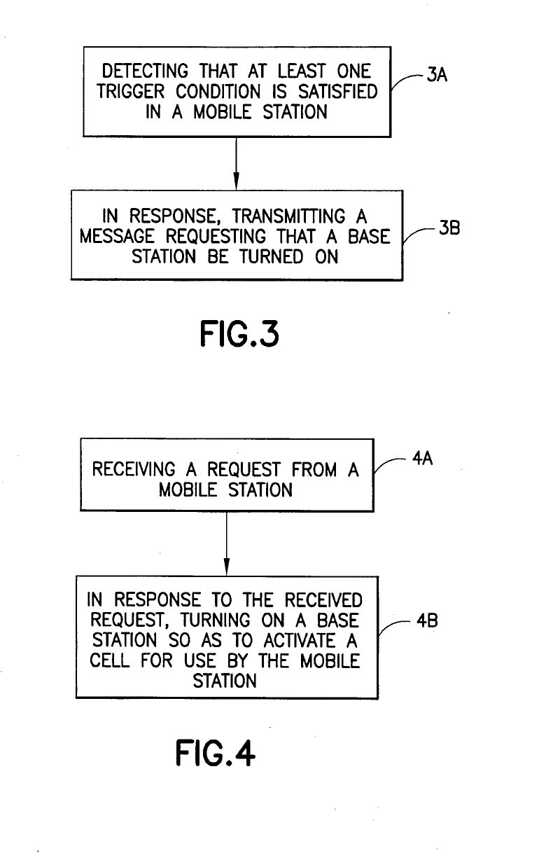

FIG. 1B reproduces FIG. 4.1 of 3GPP TS 36.300 and shows the overall architecture of the EUTRAN system (Rel-8). The E-UTRAN system includes eNBs, providing the E-UTRAN user plane (PDCP/RLC/MAC/PHY) and control plane (RRC) protocol terminations towards the UEs. The eNBs are interconnected with each other by means of an X2 interface. The eNBs are also connected by means of an S1 interface to an EPC, more specifically to a MME by means of a S1 MME interface and to a S-GW by means of a S1 interface (MME/S-GW 4). The S1 interface supports a many-to-many relationship between MMEs/S-GWs/UPEs and eNBs.

Also of interest herein is 3GPP TS 36.331 V10.0.0 (2010-12) Technical Specification 3rd Generation Partnership Project; Technical Specification Group Radio Access Network; Evolved Universal Terrestrial Radio Access (E-UTRA); Radio Resource Control (RRC); Protocol specification (Release 10).

According to a definition of base station (BS) classes in section 4.2 of 3GPP TS 25.367 V9.5.0 (2010-12) Technical Specification 3rd Generation Partnership Project; Technical Specification Group Radio Access Network; Mobility procedures for Home Node B (HNB); Overall description; Stage 2 (Release 9), there are wide area base stations (WABS), medium range base stations (MRBS), local area base stations (LABS) and home base stations (HBS). Wide area base stations are characterized by requirements derived from macro cell scenarios with a BS to user equipment (UE) minimum coupling loss equal to 70 db. The wide area base station class has the same requirements as that of base stations for general purpose applications. Medium range base stations are characterised by requirements derived from micro cell scenarios with a BS to UE minimum coupling loss equal to 53 db. Local area base stations are characterised by requirements derived from pico cell scenarios with a BS to UE minimum coupling loss equal to 45 db. Home base stations are characterised by requirements derived from femto cell scenarios. Some base stations can be closed subscriber group (CSG) base stations. A CSG is a 3GPP term used to describe a limited set of users with connectivity access to a femto cell, i.e., only those user's on an access control list are allowed to use the femto cell resources. In some cases a wide area base station can function as a CSG base station for some users, and as a normal wide area base station for other users. In other cases a MRBS 12B or a LABS 12C can function as a CSG BS. The coverage areas of the cells of, for example, a given WABS 12A and a CSG BS can overlap at least partially.

In some embodiments, such as sectored antenna embodiments, a given BS 12 can support more than one cell.

A goal of the exemplary embodiments of this invention is to provide enhanced power efficiencies in wireless communication systems including these and other types of base stations.

FIG. 1A is an overall block diagram of a wireless communications system 1 having network elements and mobile user elements, and that is operated in accordance with the exemplary embodiments of this invention. In the exemplary system embodiment shown in FIG. 1A there is at least one mobile station (MS) 10. Without a loss of generality the MS 10 can be referred to as a mobile node (MN), or as a mobile terminal (MT), or as the user equipment (UE). The MS 10 is capable of conducting bidirectional radio frequency (RF) communications with one or more base stations (BSs) 12. In this non-limiting example there are found an assortment of base stations 12, including WABSs 12A, MRBSs 12B, LABs 12C and a HBS 12D. Not all of these may be present in a given system or system area. The WABS 12A may be cellular-type BSs and can conform to any type of cellular standard/protocol. Non-limiting examples of such standards include UMTS, GSM and LTE (E-UTRAN). The BSs 12 can be referred to, without a loss of generality, as access points (APs), access nodes (ANs), Node Bs (in UMTS), base transceiver station (BTS) in GSM and as evolved Node Bs (eNBs, as in the long term evolution (LTE) and LTE-Advanced systems). As should be appreciated, the exemplary embodiments of this invention can be used with any type of BS, and are not constrained for use with any particular type or types of BSs.

In this example there is also shown at least one network element 14 connected via some network infrastructure control path 16 to some or all of the BSs 12. As a non-limiting example, in the LTE LIE-Advanced type of system the network element 14 can be an operations and maintenance (OAM) network entity that is based on some type of computing platform including one or more data processors operating under control of software stored in one or more memories.

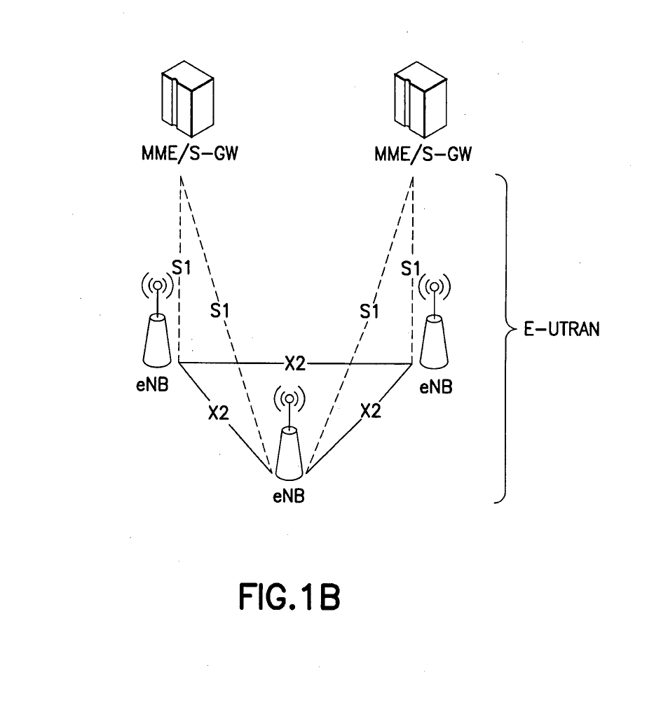

FIG. 2A is representative of the general architecture of the BSs 12. A given one of the BSs 12 in general can be divided into a radio section and a control section. The control section includes a controller, such as at least one computer or a data processor (DP) 20 and at least one computer-readable memory medium embodied as a memory 22 that stores a program of computer instructions 24. The radio section includes at least one suitable RF transceiver (transmitter TX and receiver RX pair) 26 for communication with the MS 10 via one or more antennas (typically several when multiple input/multiple output (MIMO) operation is in use), as well as the necessary related radio frequency and baseband (BB) circuitry. The BS 12 also includes at least one interface 28 for connecting the BS 12 to wireless system infrastructure components and to data networks, such as wide area packet data networks (PDNs), including the Internet, and local area networks (LANs). In some embodiments the network is a wireless local area network (WLAN) and the BS 12 serves as the wireless attachment point (AN or AP) for the MS 10. In a non-limiting example, when embodied as an eNB the interface 28 can be an S1 interface connecting the eNB to a mobility management entity (MME) and to the network element 14 (e.g., OAM entity), as well as an X2 interface for connecting the eNB to other eNBs.

Referring to FIG. 2B, the MS 10 in general can also be divided into a radio section and a control section. The control section includes a controller, such as at least one computer or a data processor (DP) 30 and at least one computer-readable memory medium embodied as a memory 32 that stores a program 34 of computer instructions. The radio section can includes at least one suitable RF transceiver (transmitter TX and receiver RX pair) 36A for communication with a cellular BS (e.g., WABS 12A) via one or more antennas, as well as the necessary related radio frequency and baseband (BB) circuitry. The MS 10 can also include a local area radio frequency transceiver 36B for communication with, for example, a LABS 12C or a HBS 12D. For the purposes of describing the exemplary embodiments of this invention the MS 10 may be assumed to also include some type of user interface (UI) 38, such as a touch sensitive display screen, or a display screen and a keypad or keyboard. The MS 10 can also include some type of location determining sub-system, such as one based on a global positioning satellite (GPS) receiver 40 and associated electronics and software.

The programs 24 and 34 are assumed to include program instructions that, when executed by the associated DP 20 or 30, enable the device to operate in accordance with the exemplary embodiments of this invention, as will be discussed below in greater detail. The exemplary embodiments of this invention may be implemented at least in part by computer software executable by the data processors 20 and 30, or by dedicated hardware, or by a combination of software and hardware (and firmware).

In general, the various embodiments of the MS 10 can include, but are not limited to, cellular telephones, personal digital assistants (PDAs) having wireless communication capabilities, portable computers having wireless communication capabilities, tablet-based computing devices having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer-readable memories 22 and 32 may be of any type suitable to the local technical environment and may be implemented using any suitable data storage technology, such as semiconductor based memory devices, random access memory, read only memory, programmable read only memory, flash memory, magnetic memory devices and systems, optical memory devices and systems, fixed memory and removable memory. The data processors 20 and 30 may be of any type suitable to the local technical environment, and may include one or more of general purpose computers, special purpose computers, microprocessors, digital signal processors (DSPs) and processors based on multi-core processor architectures, as non-limiting examples.

The components shown in FIGS. 2A and 2B can be seen to represent various means configured to implement the exemplary embodiments of this invention. For example, in FIG. 2B there are means for detecting that at least one trigger condition is satisfied in a mobile station (data processor 30 in combination with memory 32 and program 34); and means, responsive to the detecting means, for transmitting a message requesting that a base station be turned on (data processor 30 in combination with memory 32, program 34 and transceiver(s) 36A, 36B). Further by example, in FIG. 2A there are means for receiving a request from a mobile station (transceiver 26) and means, responsive to the received request, for turning on a base station so as to activate a cell for use by the mobile station (data processor 20 in combination with memory 22, program 24 and one or both of transceiver 26 and interface 28).

An aspect of this invention is a procedure for switching a cell “on”, where a cell can be assumed to be or to represent a communication coverage area associated with a particular BS 12. In general, switching a cell on can be assumed to be equivalent to transitioning the cell (BS 12) from a sleep state (low power state) to an active, powered state capable of conducting wireless communications with the MS 10. Note that when in the inactive sleep state it can be the case that only the radio section of the BS 12 is powered down or powered off, while the control section may still be powered at least to some extent so that the control section can respond to a receipt of a message/command to transition from the sleep state to the active state. Note also that when in the active state the BS 12 can also be commanded to enter the sleep state, or it could enter the sleep state on its own volition based on, for example, an inactivity timer expiring indicating that no MSs 10 are using the BS 12.

In accordance with various network centric embodiments of this invention, a cell can be activated autonomously by the network (for example using “wake-on-LAN”) when the MS 10 enters a macro cell coverage area where the cell to be turned on is located. For example, in FIG. 1A the MS 10 enters the macro cell of one of the WABSs 12A, is detected by the WABS 12A, and the WABS 12A, or the network element 14 connected to the WABS 12A, sends a message to the LABS 12C to turn on (e.g., apply power to) the radio section of the LABS 12C.

Wake-on-LAN (WOL) is an Ethernet computer networking standard that allows a computer to be turned on or woken up by a network message. The message can be sent by a program executed on another computer on the same local area network. Equivalent terms include Wake On WAN, Remote Wake-up, Power On By LAN, Power Up By LAN, Resume by LAN, Resume on LAN, Wake Up On LAN. In case the computer being woken is communicating via Wi-Fi, a supplementary standard Wake on Wireless LAN (WoWLAN) is employed.

Further in accordance with the various network centric approaches, a CSG cell can be activated by a BS 12, or by the network element 14, using, for example, a “wake-on-LAN” message after the MS 10 has transmitted a proximity indication (indicating proximity of the CSG cell). Note also that in LTE embodiments of this invention the X2 interface between eNBs (see FIG. 1B) can be used to provide the signaling needed to wake up a BS.

Further in accordance with the various network centric approaches, the cell activation can be based on the number of MSs 10 in a connected mode in the macro cell. For example, when some threshold number of MSs 10 are in the connected state with a cell A, the BS 12 or the network element 14 can send a message to turn on another cell (activate another BS 12).

Further in accordance with the various network centric approaches, the turn-on of a sleeping cell can be based on measurements reported by the MS 10 to the network, e.g., to a WABS 12A, such as an eNB, of the network. Based on the received measurements the network can deduce the need for activation of, for example, a LABS 12C or a MRBS 12B in the vicinity of the active MS 10.

In accordance with various mobile station centric embodiments of this invention, the MS 10 can request the activation of a cell via some other radio, e.g., Bluetooth, WLAN, or any other radio, such as the local area RF transceiver 36B. For example, the MS 10 can request via the HBS 12D that the LABS 12C be turned on.

Further in accordance with various mobile station centric embodiments of this invention, the MS 10 can request that a certain cell to be switched on via a separate signaling message, e.g., through a message sent through a macro cell coverage area of a WABS 12A indicating, for example, one or more CSG identities which are requested to be switched on. In addition, a cell identity (Global Cell identity) or some other unique identifier(s) (identifying one or more cells) can be used.

While the foregoing techniques can be established and specified via standardization, such as 3GPP standardization or IEEE 802 standardization, in other embodiments these techniques can be implemented via vendor-specific (BS vendor and/or MS vendor) mechanisms.

There can be various trigger conditions for sending the “turn-on” message in the MS 10 approaches discussed above. For example, in the MS 10 the turn-on message can be sent based on one or more of the following conditions being satisfied.

(A) The MS 10 can send the turn-on message when it detects that it has no wireless network coverage (access) at all. In this case the turn-on message could be sent periodically (e.g., every 5 minutes) until the MS 10 detects the presence of an active cell that is suitable for use by the MS 10 in conducting wireless communications.

(B) The MS 10 can send the turn-on message when it detects that radio quality/signal strength levels of a currently serving cell have degraded below some threshold which could make further communications problematic.

(C) The MS 10 can send the turn-on message when it detects that the proximity of a cell by use of the GPS 40 or by any other means. For example, the MS 10 may store location coordinates of one or more cells that it has previously connected to, and upon detecting that the current location of the MS 10 is within a coverage area of one of these historically used cells can transmit the turn-on message.

(D) The MS 10 can send the turn-on message in response to user input via the user interface 38 (user initiated).

(E) The MS 10 can send the turn-on message when it detects a user initiated ‘remote’ CSG activation. For example the user can initiate CSG cell activation through the user interface 38, which then results in the MS 10 sending an “activation request” message to the network including an appropriate identification of a target cell to be activated. In response a reply message can be received from the network. The reply message can be useful to prevent the MS 10 from repeating the “activation request” message unnecessarily, and it can also be used to initiate scanning by the MS 10 to detect the activated CSG cell. Alternatively (or in complement) to using the reply message a timer could be used to restrict the amount of activation messages from the MS 10. Note that this approach can also be used to trigger an autonomous MS 10 search function together with the turn-on of the CSG cell.

(F) The MS 10 can send the turn-on message in response to the user initiating some application program, such as a browser application or a voice over Internet Protocol (VoIP) application which, by default, will require the MS 10 to connect via some BS 12 to the Internet or to some other packet data network.

A graduated turn-on procedure can be applied in order to allow for a cell (e.g., a femto cell associated with the HBS 12D) to quickly power off in case of access restrictions or similar constraints. In this scenario if a cell is requested to be turned on then the cell provides only sufficient information/channels so that the MS 10 can determine if it can access the cell (e.g., the MS 10 receives MIB and/or SIB Type 1 in LTE). In this case, and only if the MS 10 is capable of accessing the cell is the BS 12 fully powered on and made fully functional. If by example there is no access on the cell within some time window the cell may power off (go to power save mode) again.

By way of background, in LTE system information includes the master information block (MIB) and a number of system information blocks (SIBs). The MIB is broadcast on the Physical Broadcast Channel (PBCH), while the SIBs are transmitted sent on the physical downlink shared channel (PDSCH) through radio resource control (RRC) messages. SIB1 is carried by “SystemInformationBlockType1” message. SIB2 and other SIBs are carried by “SystemInformation(SI)” message. An SI message can contain one or several SIBs. The MIB is the first message that the MS 10 (UE in the LTE system) needs to receive after it achieves downlink synchronization. The MIB carries information that is needed to acquire other information from the cell. The SIB1 includes information related to MS 10 cell access and defines the schedules of other SIBs, including transmission times and periodicities of other SIBs. The SIB1 also conveys the PLMN identities of the network, a tracking area code (TAC) and cell ID, possible CSG information, a cell barring status to indicate whether or not the MS 10 can camp on the cell, and a parameter that indicates a minimum required receive level in the cell to fulfill cell selection criteria.

In this embodiment some of all of this information, or equivalent information, can be used by the MS 10 to determine if it can access the cell.

One way of realizing this functionality with regard to the E-UTRAN system and specification using a HeNB (home eNB, which could possibly be a CSG cell) as an example would be to include appropriate information into the proximity indication message. The details of the proximity indication functionality can be seen in, e.g., the above cited 3GPP TS 36.331 in section 5.3.14. The actual message used in the example is given in section 6.2.2 ‘ProximityIndication’, reproduced below:

‘
- ProximityIndication

The ProximityIndication message is used to indicate that the UE is
entering or leaving the proximity of one or more cells whose CSG IDs
are in the UEs CSG whitelist.
Signalling radio bearer: SRB1
RLC-SAP: AM
Logical channel: DCCH
Direction: UE to E-UTRAN

ProximityIndication message

-- ASN1START
ProximityIndication-r9 ::= SEQUENCE {

| | |
|---|---|
| criticalExtensions | CHOICE { |
| c1 | CHOICE { |

```
      proximityIndication-r9
  ProximityIndication-r9-IEs,
      spare3 NULL, spare2 NULL, spare1 NULL
      },
```

| | |
|---|---|
| criticalExtensionsFuture | SEQUENCE { } |

}
}
ProximityIndication-r9-IEs ::= SEQUENCE {

| | |
|---|---|
| type-r9 | ENUMERATED {entering, |
| leaving}, | |
| carrierFreq-r9 | CHOICE { |
| eutra-r9 | ARFCN-ValueEUTRA, |
| utra-r9 | ARFCN-ValueUTRA, |
| ... | |
| }, | |
| nonCriticalExtension | ProximityIndication-v930- |
| IEs optional | |

ProximityIndication-v930-IEs ::= SEQUENCE {

| | |
|---|---|
| lateNonCriticalExtension | OCTET STRING |
| OPTIONAL, | |
| nonCriticalExtension | SEQUENCE { } |

OPTIONAL
}
-- ASN1STOP

ProximityIndication field descriptions

Type
Used to indicate whether the UE is entering or leaving the proximity of
cell(s) whose CSG IDs are in the UEs CSG whitelist.
carrierFreq
Indicates the RAT and frequency of the cell(s), whose CSG IDs are in the
UEs CSG whitelist, for which the proximity indication is sent.
’

By way of example to illustrate one solution, the UE could, when conditions for sending the proximity indication message has been fulfilled (e.g. UE internal finger print match, location knowledge by GPS or other means e.g. as those indicated above), send the message indicated above including information that enables the network to identify the concerned cell. This information could, for example, be the Cell Global Identity, the CSG identity, both of these identities, or some other identity that enables the eNB to identify the cell. Using the Cell Global Identity from E-UTRAN as example:

- CellGlobalIdEUTRA

The IE CellGlobalIdEUTRA specifies the Evolved Cell Global
Identifier (ECGI), the globally unique identity of a cell in E-UTRA.

CellGlobalIdEUTRA information element

| | |
|---|---|
| -- ASN1START | |
| CellGlobalIdEUTRA ::= | SEQUENCE { |
| plmn-Identity | PLMN-Identity, |
| cellIdentity | CellIdentity |
| } | |
| -- ASN1STOP | |

CellGlobalIdEUTRA field descriptions

plmn-Identity
Identifies the PLMN of the cell as given by the first PLMN entry in the
plmn-IdentityList in SystemInformationBlockType1.
cellIdentity
Identity of the cell within the context of the PLMN.
’

This information element would be included in the proximity indication message in an appropriate way.

It should be appreciated that the various embodiments and approaches discussed above are not limited to CSG cell(s) activation/deactivation, and they can be utilized for any type of wireless base station activation.

Based on the foregoing it should be apparent that the exemplary embodiments of this invention provide a method, apparatus and computer program(s) to enhance and optimize the power consumption of base stations.

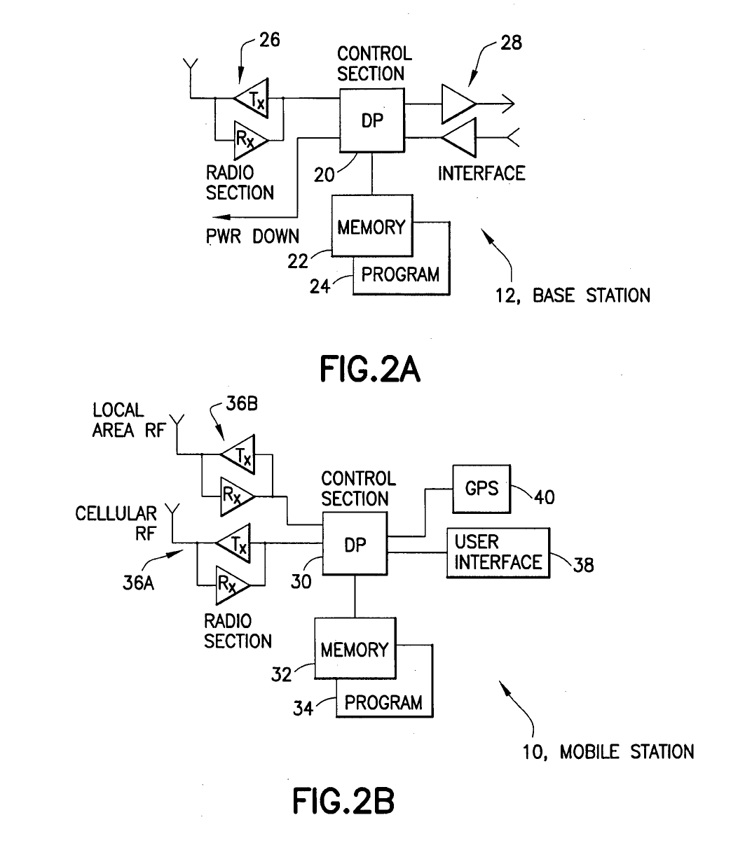

FIG. 3 is a logic flow diagram that illustrates the operation of a method, and a result of execution of computer program instructions, in accordance with the exemplary embodiments of this invention. In accordance with these exemplary embodiments a method performs, at Block 3A, a step of detecting that at least one trigger condition is satisfied in a mobile station and, at Block 3B a step of, in response, transmitting a message requesting that a base station be turned on.

In the method of FIG. 3, where the at least one trigger condition that is satisfied is that the mobile station has no wireless network access.

In the method of FIG. 3 and the preceding paragraph, where the message is transmitted periodically until the mobile station detects that is has wireless network access.

In the method of FIG. 3 and the preceding paragraphs descriptive of FIG. 3, where the at least one trigger condition that is satisfied is that the mobile station detects that radio quality/signal strength levels of a currently serving cell have degraded below a threshold level.

In the method of FIG. 3 and the preceding paragraphs descriptive of FIG. 3, where the at least one trigger condition that is satisfied is that the mobile station detects that its current location corresponds to the location of a cell previously used by the mobile station.

In the method of FIG. 3 and the preceding paragraphs descriptive of FIG. 3, where the at least one trigger condition that is satisfied is that the mobile station detects a user input.

In the method of FIG. 3 and the preceding paragraph, where the user input corresponds to a user initiated remote closed subscriber group cell activation command.

In the method of FIG. 3 and the preceding paragraph, further comprising transmitting information expressive of an identification of a target closed subscriber group cell to be activated.

In the method of FIG. 3 and the preceding several paragraphs, further comprising receiving a reply message and, in response, at least one of terminating the sending of a further instance of the message and initiating scanning to detect the activated closed subscriber group cell.

In the method of FIG. 3 and the preceding paragraphs descriptive of FIG. 3, where the at least one trigger condition that is satisfied is that the mobile station detects a user has initiated an application program that requires the mobile station to connect to a cell to obtain access to a packet data network.

In the method of FIG. 3 and the preceding paragraphs descriptive of FIG. 3, where the message is transmitted to one of a wide area base station, a medium range base station, a local area base station and a home base station.

In the method of FIG. 3 and the preceding paragraphs descriptive of FIG. 3, and further comprising receiving information that is sufficient for the mobile station to make an initial determination if it can access a cell associated with a base station that has been turned on.

The exemplary embodiments of this invention also encompass a non-transitory computer-readable medium that contains software program instructions, where execution of the software program instructions by at least one data processor results in performance of operations that comprise execution of the method of FIG. 3 and the preceding paragraphs descriptive of FIG. 3.

FIG. 4 is a logic flow diagram that illustrates the operation of a method, and a result of execution of computer program instructions, further in accordance with the exemplary embodiments of this invention. In accordance with these exemplary embodiments a method performs, at Block 4A, a step of receiving a request from a mobile station. In Block 4B there is a step performed, in response to the received request, of turning on a base station so as to activate a cell for use by the mobile station.

In the method shown in FIG. 4, turning on the base station comprises sending a wake-on-local area network command to the base station.

In the method of FIG. 4 and the preceding paragraphs descriptive of FIG. 4, the request comprises information indicating that the mobile station is in proximity to the base station.

In the method of FIG. 4 and the preceding paragraphs descriptive of FIG. 4, where turning on the base station is accomplished using inter-base station signaling.

In the method of FIG. 4 and the preceding paragraphs descriptive of FIG. 4, the request comprises information expressive of an identification of a target closed subscriber group cell to be activated.

In the method of FIG. 4 and the preceding paragraphs descriptive of FIG. 4, and further comprising transmitting a reply message to the mobile station.

In the method of FIG. 4 and the preceding paragraphs descriptive of FIG. 4, the request comprises information expressive of a unique identity of one or more cells to be activated.

In the method of FIG. 4 and the preceding paragraph, the information comprises a cell global identifier.

In the method of FIG. 4 and the preceding paragraphs descriptive of FIG. 4, the request is received at one of a wide area base station, a medium range base station, a local area base station and a home base station.

In the method of FIG. 4 and the preceding paragraphs descriptive of FIG. 4, the base station that is turned on provides at least information that is sufficient for the mobile station to make an initial determination if it can access a cell associated with the base station that has been turned on.

The exemplary embodiments also encompass a non-transitory computer-readable medium that contains software program instructions, where execution of the software program instructions by at least one data processor results in performance of operations that comprise execution of the method of FIG. 4 and the preceding paragraphs descriptive of FIG. 4.

The various blocks shown in FIGS. 3 and 4 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above at least in part in the context of the E-UTRAN (UTRAN-LTE) system, it should be appreciated that the exemplary embodiments of this invention are not limited for use with only this one particular type of wireless communication system, and that they may be used to advantage in other wireless communication systems such as, for example, WLAN, UTRAN and GSM systems.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters are not intended to be limiting in any respect, as these parameters may be identified by any suitable names. Further, the various names assigned to different channels (e.g., PDCH, PDSCH) are not intended to be limiting in any respect, as these various channels may be identified by any suitable names.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1-48. (canceled)

49. A method, comprising:
detecting that at least one trigger condition is satisfied in a mobile station; and
in response, transmitting a message requesting that a base station be turned on.

50. The method of claim 49, where the at least one trigger condition that is satisfied is that the mobile station detects at least one of: the mobile station has no wireless network access, radio quality or signal strength levels of a currently serving cell have degraded below a threshold level, current location of the mobile station corresponds to the location of a cell previously used by the mobile station, a user input, and a user has initiated an application program that requires the mobile station to connect to a cell to obtain access to a packet data network.

51. The method of claim 50, where the user input corresponds to a user initiated remote closed subscriber group cell activation command.

52. The method of claim 51, further comprising transmitting information expressive of an identification of a target closed subscriber group cell to be activated.

53. The method of claim 52, further comprising receiving a reply message and, in response, at least one of terminating the sending of a further instance of the message and initiating scanning to detect the activated closed subscriber group cell.

54. The method of claim 49, where the message is transmitted to one of a wide area base station, a medium range base station, a local area base station and a home base station.

55. The method of claim 49, further comprising receiving information that is sufficient for the mobile station to make an initial determination if it can access a cell associated with a base station that has been turned on.

56. An apparatus, comprising:
a processor; and a memory including computer program code, where the memory and computer program code are configured to, with the processor, cause the apparatus to detect that at least one trigger condition is satisfied and, in response, to transmit a message requesting that a base station be turned on.

57. The apparatus of claim 56, where the at least one trigger condition that is satisfied is that the apparatus detects at least one of: the apparatus has no wireless network access, radio quality or signal strength levels of a currently serving cell have degraded below a threshold level, current location of the apparatus corresponds to the location of a cell previously used by the apparatus, a user input, and a user has initiated an application program that requires the apparatus to connect to a cell to obtain access to a packet data network.

58. The apparatus of claim 57, where the user input corresponds to a user initiated remote closed subscriber group cell activation command.

59. The apparatus of claim 58, where the apparatus is further caused to transmit information expressive of an identification of a target closed subscriber group cell to be activated.

60. The apparatus of claim 59, where the apparatus is further caused to receive a reply message and, in response, at least one of terminate the sending of a further instance of the message and initiate scanning to detect the activated closed subscriber group cell.

61. The apparatus of claim 56, where the message is transmitted to one of a wide area base station, a medium range base station, a local area base station and a home base station.

62. The apparatus of claim 56, where the apparatus is further caused to receive information that is sufficient for the apparatus to make an initial determination if it can access a cell associated with a base station that has been turned on.

63. A method, comprising:
receiving a request from a mobile station; and
in response to the received request, turning on a base station so as to activate a cell for use by the mobile station.

64. The method of claim 63, where turning on the base station comprises sending a wake-on-local area network command to the base station.

65. The method of claim 63, where the request comprises information indicating that the mobile station is in proximity to the base station.

66. The method of claim 63, where the request comprises information expressive of at least one of an identification of a target closed subscriber group cell to be activated and a unique identity of one or more cells to be activated.

67. The method of claim 63, where the request is received at one of a wide area base station, a medium range base station, a local area base station and a home base station.

68. The method of claim 63, where the base station that is turned on provides at least information that is sufficient for the mobile station to make an initial determination if it can access a cell associated with the base station that has been turned on.
